(19) United States
(12) Patent Application Publication
(10) Pub. No.: US 2007/0006019 A1
(43) Pub. Date: Jan. 4, 2007

(54) Data storage system

(76) Inventor: Hung-Ming Chien, Hsinchu City (TW)

Correspondence Address: LAW OFFICES OF JOHN CHUPA & ASSOCIATES, P.C., 28535 ORCHARD LAKE ROAD, SUITE 50, FARMINGTON HILLS, MI, 48334, US

(21) Appl. No.: 11/217,054

(22) Filed: Aug. 31, 2005

(30) Foreign Application Priority Data
Jul. 1, 2005 (TW) 094100560

(51) Int. Cl. G06F 11/00

(52) U.S. Cl. 714/6

(57) ABSTRACT

A data storage system including an array of storage devices and a storage controller is provided. The array of storage devices is configured to store information in the form of a plurality of stripes. The storage controller is configured to write a plurality of code words forming each stripe to the array of storage devices. Each code word comprises a plurality of data blocks and at least one redundancy block. A redundancy check matrix is previously provided and one subset including any k columns of elements in the redundancy check matrix is invertible. The storage controller generates the redundancy block according to the plurality of data blocks and the redundancy check matrix. Once up to k storage devices among the array of storage devices are failed, the other un-failed storage devices and the redundancy check matrix are utilized to recover the failed storage devices.

### BACKGROUND OF THE INVENTION

1. Field of the Invention

This invention relates to a data storage system. More specifically, the invention relates to a data storage system including an array of storage devices and providing multiple-faults protection.

2. Description of the Prior Art

In recent years, the speed and efficiency of computers are continuously raised and the capacities of storage systems are highly increased. Besides capacity and performance, reliability of large storage systems is also extremely important. To achieve better reliability, the abilities of error detection and error correction must be improved in large storage systems.

An array of storage devices is usually used for providing a larger data capacity than one single storage device. A technique named “redundancy” is frequently applied in arrays of storage devices. Redundancy means adding additional storage devices to store information about data in the original storage devices. Once the storage devices for storing data are failed, the data storage system can recover the data in the failed storage devices according to the redundancy information.

In actual applications, an array of storage devices may include a plurality of disks. Existing redundant arrays of independent disks (RAID) can be classified into the following categories: RAID 0, RAID 1, RAID 10, RAID 0+1, RAID 2, RAID 3, RAID 53, RAID 4, RAID 5 and RAID 6.

However, conventional RAIDs in prior arts can not provide sufficient protection for data or can only provide protection for data with a large amount of additional disk drives. RAID0 doesn't provide any redundancy. RAID1 provides single-fault protection by providing duplicate disk drives for each of the disk drives in the RAID 0 array. RAID 2, RAID3, RAID 4, and RAID 5 can also only provide single-fault protection, and once more than one disk drive is failed, the failed disk drives cannot be recovered. RAID 6 needs two additional disk drives for recovering two failed disk drives and once more than two disk drives are failed simultaneously, the failed disk drives can not be recovered.

The main purpose of this invention is providing a data storage system including an array of storage devices. More particularly, once up to k storage devices in the array of storage devices are failed, the data storage system recovers the failed storage devices based on a previously provided redundancy check matrix, wherein k can be a natural number larger than two. Accordingly, this invention provides a data storage system having multiple-faults protections and the data storage system can tolerate more failed storage devices than prior arts.

### SUMMARY OF THE INVENTION

The main purpose of this invention is to provide a data storage system. A redundancy check matrix with k rows and n columns of elements is previously provided in the data storage system. Any sub-matrix including k columns of elements among the n columns of elements in the redundancy check matrix is invertible, wherein k is a natural number and n is a natural number larger than k.

The data storage system of one preferred embodiment according to this invention includes an array of storage devices and a storage controller. The array of storage devices is configured to store information in the form of a plurality of stripes. The storage controller is coupled to the array of storage devices and configured to write a plurality of code words forming each stripe to the array of storage devices. The plurality of code words represents a systematic mapping of a plurality of data blocks according to the redundancy check matrix and includes the plurality of data blocks and at least one redundancy block. The storage controller includes an encoder configured to generate the at least one redundancy block according to the plurality of data blocks and the redundancy check matrix in an encoding mode.

The advantage and spirit of the invention may be understood by the following recitations together with the appended drawings.

### BRIEF DESCRIPTION OF THE APPENDED DRAWINGS

FIG. 1 is the data storage system of one preferred embodiment according to this invention.

### DETAILED DESCRIPTION OF THE INVENTION

The main purpose of this invention is to provide a data storage system. A redundancy check matrix with k rows and n columns of elements is previously provided in the data storage system. Any sub-matrix including k columns of elements among the n columns of elements in the redundancy check matrix is invertible, wherein k is a natural number and n is a natural number larger than k.

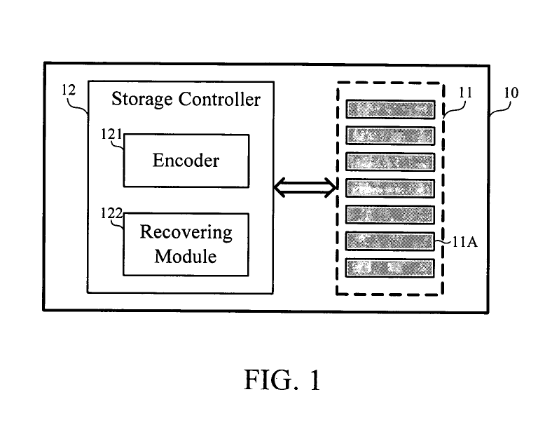

Please refer to FIG. 1. A data storage system of one preferred embodiment according to this invention is shown in FIG. 1. The data storage system 10 includes an array of storage devices 11 and a storage controller 12. The array of storage devices 11 includes a plurality of storage devices 11A and is configured to store information in the form of a plurality of stripes. The storage controller 12 is coupled to the array of storage devices 11 and configured to write a plurality of code words forming each stripe to the storage devices 11A. The plurality of code words represents a systematic mapping of a plurality of data blocks according to the redundancy check matrix and includes the plurality of data blocks and at least one redundancy block. In actual applications, the storage devices 11A can be disk drives.

The storage controller 12 includes an encoder 121 configured to generate the at least one redundancy block according to the plurality of data blocks and the redundancy check matrix in an encoding mode. The storage controller 12 also includes a recovering module 122. Once up to k storage devices 11A in the array of storage devices 11 are failed, the recovering module 122 recovers the code words in the failed storage devices 11A based on the redundancy check matrix and the code words in the other un-failed storage devices 11A.

In actual applications, the redundancy check matrix can be a Vandermonde matrix. A k×n Vandermonde matrix is usually represented as:

$$[ \begin{matrix}{a}_{1}^{0} & {a}_{2}^{0} & Λ & {a}_{( n - k )}^{0} & {a}_{( n - k + 1 )}^{0} & {a}_{( n - k + 2 )}^{0} & Λ & {a}_{n}^{0} \\ {a}_{1}^{1} & {a}_{2}^{1} & Λ & {a}_{( n - k )}^{1} & {a}_{( n - k + 1 )}^{1} & {a}_{( n - k + 2 )}^{1} & Λ & {a}_{n}^{1} \\ M & M & Λ & M & M & M & Λ & M \\ {a}_{1}^{k - 1} & {a}_{2}^{k - 1} & Λ & {a}_{( n - k )}^{k - 1} & {a}_{( n - k + 1 )}^{k - 1} & {a}_{( n - k + 2 )}^{k - 1} & Λ & {a}_{n}^{k - 1}\end{matrix} ] .$$

{a₁, a₂, . . . , aₙ} in the Vandermonde matrix are n elements different from each other. As known by people skilled in the art, Vandermonde matrix is invertible, i.e. the inverse matrix of the Vandermonde matrix must exist. The invertible property of Vandermonde matrix insures that a k×k Vandermonde matrix can generate k independent equations, thus, k specific solutions for the k independent equations can be obtained.

In the data storage system 10, the redundancy check matrix is selected as a Vandermonde matrix (R):

$$R = [ \begin{matrix}1 & 1 & Λ & 1 & 1 \\ {a}_{1} & {a}_{2} & Λ & {a}_{( n - k )} & {a}_{( n - k + 1 )} \\ M & M & Λ & M & M \\ {a}_{1}^{k - 1} & {a}_{2}^{k - 1} & Λ & {a}_{( n - k )}^{k - 1} & {a}_{( n - k + 1 )}^{k - 1}\end{matrix} \begin{matrix}1 & Λ & 1 \\ {a}_{( n - k + 2 )} & Λ & {a}_{n} \\ M & Λ & M \\ {a}_{( n - k + 2 )}^{k - 1} & Λ & {a}_{n}^{k - 1}\end{matrix} ] .$$

Assume the array of the storage devices 11 includes n storage devices 11A and a first stripe in the array of storage devices 11 includes (n-k) subsets of data blocks (D₁, D₂, . . . , D₍ₙ₋ₖ₎) and k subsets of redundancy blocks (C₁, C₂, . . . , Cₖ), wherein each subset is stored in one storage device 11A in the array of storage device 11, respectively.

In an encoding mode, the encoder 121 generates the k subsets of redundancy blocks according to the (n-k) subsets of data blocks and the redundancy check matrix R.

The multiplying result of the (n-k) subsets of data blocks (D₁, D₂, . . . , D₍ₙ₋ₖ₎) and the first (n-k) columns of the redundancy check matrix is assumed as a set of parameters (S₁, S₂, . . . , Sₖ):

$$[ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{( n - k )}^{k - 1}\end{matrix} ] ⊗ [ \begin{matrix}{D}_{1} \\ {D}_{2} \\ M \\ {D}_{( n - k )}\end{matrix} ] = [ \begin{matrix}{S}_{1} \\ {S}_{2} \\ M \\ {S}_{k}\end{matrix} ] , \qquad ( Equation 1 )$$

wherein the \textcircled{x} symbol represents a multiplication operator in Galois field.

The k subsets of redundancy blocks (C₁, C₂, . . . , Cₖ) are generated by multiplying the negative-signed parameters (−S₁, −S₂, . . . , −Sₖ) and the inverse matrix of the sub-matrix with the last k columns of the redundancy check matrix:

$$[ \begin{matrix}{C}_{1} \\ {C}_{2} \\ M \\ {C}_{k}\end{matrix} ] = {[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ [ \begin{matrix}- {S}_{1} \\ - {S}_{2} \\ M \\ - {S}_{k}\end{matrix} ] , \qquad ( Equation 2 )$$

Since the redundancy check matrix is a Vandermonde matrix, the inverse matrix in Equation 2 must exist.

Equation 2 can be re-written as:

$$[ \begin{matrix}{S}_{1} \\ {S}_{2} \\ M \\ {S}_{k}\end{matrix} ] = - [ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ] ⊗ [ \begin{matrix}{C}_{1} \\ {C}_{2} \\ M \\ {C}_{k}\end{matrix} ] . \qquad ( Equation 3 )$$

According to Equation 1 and Equation 3, the following equation can be obtained:

$$[ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{( n - k )}^{k - 1}\end{matrix} ] ⊗ [ \begin{matrix}{D}_{1} \\ {D}_{2} \\ M \\ {D}_{( n - k )}\end{matrix} ] = - [ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ] ⊗ [ \begin{matrix}{C}_{1} \\ {C}_{2} \\ M \\ {C}_{k}\end{matrix} ] \qquad ( Equation 4 )$$

Based on Equation 4, the encoder 121 generates the k subsets of redundancy blocks according to the following equation:

$$[ \begin{matrix}{C}_{1} \\ {C}_{2} \\ M \\ {C}_{k}\end{matrix} ] = - {[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ [ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{n}^{k - 1}\end{matrix} ] ⊗ [ \begin{matrix}{D}_{1} \\ {D}_{2} \\ M \\ {D}_{( n - k )}\end{matrix} ] . \\ {[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ [ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{n}^{k - 1}\end{matrix} ] \qquad ( Equation 5 )$$

in Equation 5 is named as a generator matrix.

Besides, based on Equation 4, the relation of the (n-k) subsets of data blocks and the k subsets of redundancy blocks satisfies the following equation:

$$[ \begin{matrix}1 & 1 & Λ & 1 & 1 & 1 & Λ & 1 \\ {a}_{1} & {a}_{2} & Λ & {a}_{( n - k )} & {a}_{( n - k + 1 )} & {a}_{( n - k + 2 )} & Λ & {a}_{n} \\ M & M & Λ & M & M & M & Λ & M \\ {a}_{1}^{k - 1} & {a}_{2}^{k - 1} & Λ & {a}_{( n - k )}^{k - 1} & {a}_{( n - k + 1 )}^{k - 1} & {a}_{( n - k + 2 )}^{k - 1} & Λ & {a}_{n}^{k - 1}\end{matrix} ] ⊗ [ \begin{matrix}{D}_{1} \\ {D}_{2} \\ M \\ {D}_{( n - k )} \\ {C}_{1} \\ {C}_{2} \\ M \\ {C}_{k}\end{matrix} ] = [ \begin{matrix}0 \\ 0 \\ M \\ 0\end{matrix} ] . \qquad ( Equation 6 )$$

Once up to k storage devices 11A in the array of storage device 11 are failed, the recovering module 122 can also recover the code words in the failed storage devices 11A based on Equation 6. Since the failed storage devices might be the storage devices storing data blocks or the storage devices storing redundancy blocks, the data blocks and redundancy blocks are all viewed as code words when introducing the operations of the recovering module 122 in the following paragraphs.

Assume a second stripe in the array of storage devise 11 includes n code words. Each code word is stored in one storage device in the array of storage device, respectively. Then, e code words (D_{f1}, D_{f2}, . . . , D_{fe}) among the n code words are assumed as failed, and the other (n-e) un-failed code words are (D_{g}_{_{—}}₁, D_{g}_{_{—}}₂, . . . , D_{g}_{_{—}}₍ₙ₋ₑ₎), wherein e is a natural number smaller than or equal to k.

Equation 6 can be re-written as:

$$[ \begin{matrix}1 & 1 & Λ & 1 & 1 & 1 & Λ & 1 \\ {a}_{f 1} & {a}_{f 2} & Λ & {a}_{fe} & {a}_{g\_ 1} & {a}_{g\_ 2} & Λ & {a}_{g\_ ( n - e )} \\ M & M & Λ & M & M & M & Λ & M \\ {a}_{f 1}^{k - 1} & {a}_{f 2}^{k - 1} & Λ & {a}_{fe}^{k - 1} & {a}_{g\_ 1}^{k - 1} & {a}_{g\_ 2}^{k - 1} & Λ & {a}_{g\_ ( n - e )}^{k - 1}\end{matrix} ] ⊗ [ \begin{matrix}{D}_{f 1} \\ {D}_{f 2} \\ M \\ {D}_{fe} \\ {D}_{g\_ 1} \\ {D}_{g\_ 2} \\ M \\ {D}_{g\_ ( n - e )}\end{matrix} ] = [ \begin{matrix}0 \\ 0 \\ M \\ 0\end{matrix} ] , \qquad ( Equation 7 )$$

{f1, f2, . . . , fe} and {g_{—}1, g_{—}2, . . . , g_(n-e)} are subsets of {1, 2, . . . , n}, respectively, and any element in the subset {g_{—}1, g_{—}2, . . . , g_(n-e)} does not belong to the subset {f1, f2, . . . , fe}.

Equation 7 can be re-written as:

$$[ \begin{matrix}1 & 1 & Λ & 1 \\ {a}_{f 1} & {a}_{f 2} & Λ & {a}_{fe} \\ M & M & Λ & M \\ {a}_{f 1}^{k - 1} & {a}_{f 2}^{k - 1} & Λ & {a}_{fe}^{k - 1}\end{matrix} ] ⊗ [ \begin{matrix}{D}_{f 1} \\ {D}_{f 2} \\ M \\ {D}_{fe}\end{matrix} ] + [ \begin{matrix}1 & 1 & Λ & 1 \\ {a}_{g\_ 1} & {a}_{g\_ 2} & Λ & {a}_{g\_ ( n - e )} \\ M & M & Λ & M \\ {a}_{g\_ 1}^{k - 1} & {a}_{g\_ 2}^{k - 1} & Λ & {a}_{g\_ ( n - e )}^{k - 1}\end{matrix} ] ⊗ [ \begin{matrix}{D}_{g\_ 1} \\ {D}_{g\_ 2} \\ M \\ {D}_{g\_ ( n - 1 )}\end{matrix} ] = [ \begin{matrix}0 \\ 0 \\ M \\ 0\end{matrix} ] . \qquad ( Equation 8 )$$

Equation 8 can be used to generate k equations, but since there are e failed code words in the second stripe, only e equations are needed to recover the e failed code words. After properly selecting e equations among the k equations corresponding to Equation 8, Equation 9 can be obtained:

$$[ \begin{matrix}{D}_{f 1} \\ {D}_{f 2} \\ M \\ {D}_{fe}\end{matrix} ] = - {[ \begin{matrix}{a}_{f 1}^{i\_ 1} \\ {a}_{f 1}^{i\_ 2} \\ M \\ {a}_{f 1}^{i\_e}\end{matrix} \begin{matrix}{a}_{f 2}^{i\_ 1} & Λ \\ {a}_{f 2 }^{i\_ 2} & Λ \\ M & Λ \\ {a}_{f 2}^{i\_e} & Λ\end{matrix} \begin{matrix}{a}_{fe}^{i\_ 1} \\ {a}_{fe }^{i\_ 2} \\ M \\ {a}_{fe}^{i\_e}\end{matrix} ]}^{- 1} ⊗ [ \begin{matrix}{a}_{g\_ 1}^{i\_ 1} \\ {a}_{g\_ 1}^{i\_ 2} \\ M \\ {a}_{g\_ 1}^{i\_e}\end{matrix} \begin{matrix}{a}_{g\_ 2}^{i\_ 1} & Λ \\ {a}_{g\_ 2 }^{i\_ 2} & Λ \\ M & Λ \\ {a}_{g\_ 2}^{i\_e} & Λ\end{matrix} \begin{matrix}{a}_{g\_ ( n - e )}^{i\_ 1} \\ {a}_{g\_ ( n - e ) }^{i\_ 2} \\ M \\ {a}_{g\_ ( n - e )}^{i\_e}\end{matrix} ] ⊗ [ \begin{matrix}{D}_{g\_ 1} \\ {D}_{g\_ 2} \\ M \\ {D}_{g\_ ( n - e )}\end{matrix} ] . \qquad ( Equation 9 )$$

{i_{—}1, i_{—}2, . . . , i_e} is a subset of {0, 1, . . . , (k−1)} and is generated by properly selecting e elements from the k elements of {0, 1, . . . , (k−1)}.

$${[ \begin{matrix}{a}_{f 1}^{i\_ 1} \\ {a}_{f 1}^{i\_ 2} \\ M \\ {a}_{f 1}^{i\_e}\end{matrix} \begin{matrix}{a}_{f 2}^{i\_ 1} & Λ \\ {a}_{f 2 }^{i\_ 2} & Λ \\ M & Λ \\ {a}_{f 2}^{i\_e} & Λ\end{matrix} \begin{matrix}{a}_{fe}^{i\_ 1} \\ {a}_{fe }^{i\_ 2} \\ M \\ {a}_{fe}^{i\_e}\end{matrix} ]}^{- 1} ⊗ [ \begin{matrix}{a}_{g\_ 1}^{i\_ 1} \\ {a}_{g\_ 1}^{i\_ 2} \\ M \\ {a}_{g\_ 1}^{i\_e}\end{matrix} \begin{matrix}{a}_{g\_ 2}^{i\_ 1} & Λ \\ {a}_{g\_ 2 }^{i\_ 2} & Λ \\ M & Λ \\ {a}_{g\_ 2}^{i\_e} & Λ\end{matrix} \begin{matrix}{a}_{g\_ ( n - e )}^{i\_ 1} \\ {a}_{g\_ ( n - e ) }^{i\_ 2} \\ M \\ {a}_{g\_ ( n - e )}^{i\_e}\end{matrix} ]$$

in equation 9 is named as a recovery matrix.

In the preferred embodiment according to this invention, the recovering module 122 recovers the e failed code words according to Equation 9.

In the preferred embodiment above, a k×n Vandermonde matrix is used as the redundancy check matrix. Since a k×k matrix formed with any combination of k columns in the Vandermonde matrix is invertible, the e equations corresponding to Equation 9 must be independent and the e failed code words can be recovered. Therefore, once up to k storage devices in the array of storage devices are failed, the data storage system according to this invention can recover the data in the failed storage devices based on Equation 9, wherein k can be a natural number larger than 2. Accordingly, this invention provides a data storage system that can tolerate more failed storage devices than prior arts.

Generally, Vandermonde matrix can also be written as the two following forms R′ and R″:

$${R}^{′} = [ \begin{matrix}{b}_{0} & {b}_{0} & Λ \\ {b}_{1} {a}_{1} & {b}_{1} {a}_{2} & Λ \\ M & M & Λ \\ {b}_{( k - 1 )} {a}_{1}^{k - 1} & {b}_{( k - 1 )} {a}_{2}^{k - 1} & Λ\end{matrix} \begin{matrix}{b}_{0} \\ {b}_{1} {a}_{( n - k )} \\ M \\ {b}_{( k - 1 )} {a}_{( n - k )}^{k - 1}\end{matrix} \begin{matrix}{b}_{0} & Λ \\ {b}_{1} {a}_{( n - k + 1 )} & Λ \\ M & Λ \\ {b}_{( k - 1 )} {a}_{( n - k + 1 )}^{k - 1} & Λ\end{matrix} \begin{matrix}{b}_{0} \\ {b}_{1} {a}_{n} \\ M \\ {b}_{( k - 1 )} {a}_{n}^{k - 1}\end{matrix} ] , and$$

$${R}^{″} = [ \begin{matrix}{b}_{1} & {b}_{2} & Λ \\ {b}_{1} {a}_{1} & {b}_{2} {a}_{2} & Λ \\ M & M & Λ \\ {b}_{1} {a}_{1}^{k - 1} & {b}_{2} {a}_{2}^{k - 1} & Λ\end{matrix} \begin{matrix}{b}_{( n - k )} \\ {b}_{( n - k )} {a}_{( n - k )} \\ M \\ {b}_{( n - k )} {a}_{( n - k )}^{k - 1}\end{matrix} \begin{matrix}{b}_{( n - k + 1 )} \\ {b}_{( n - k + 1 )} {a}_{( n - k + 1 )} \\ M \\ {b}_{( n - k )} {a}_{( n - k )}^{k - 1}\end{matrix} \begin{matrix}{b}_{( n - k + 2 )} & Λ \\ {b}_{( n - k + 2 )} {a}_{( n - k + 2 )} & Λ \\ M & Λ \\ {b}_{( n - k + 2 )} {a}_{( n - k + 2 )}^{k - 1} & Λ\end{matrix} \begin{matrix}{b}_{0} \\ {b}_{1} {a}_{n} \\ M \\ {b}_{k - 1} {a}_{n}^{k - 1}\end{matrix} ] .$$

{b₀, b₁, . . . , b₍ₖ₋₁₎} in R′ and {b₁, b₂, . . . , bₙ} in R″ are constants. As long as those constants are non-zero, R′ and R″ are also invertible; thus, R′ and R″ can be used as redundancy check matrix according to this invention, too.

As shown in Equation 5 and Equation 9, the operations in the encoder 121 and the recovering module 122 are similar, thus, the circuits in the two circuits are almost the same. The similarity of operations in the encoder 121 and the recovering module 122 is another advantage of this invention for reduced designing resources of circuits.

Although the redundancy check matrix in the preferred embodiment above is a Vandermonde matrix, redundancy check matrixes according to this invention are not limited in Vandermonde matrixes. In actual applications, any matrix whose any combination of k columns has a inverse matrix exists can be used as the redundancy check matrix in data storage systems according to this invention. A general form of redundancy check matrix according to this invention can be represented as:

$$[ \begin{matrix}{a}_{1 \_ 1} & {a}_{1 \_ 2} & Λ & {a}_{1 \_ ( n - k )} & {a}_{1 \_ ( n - k + 1 )} & {a}_{1 \_ ( n - k + 2 )} & Λ & {a}_{1 \_n} \\ {a}_{2 \_ 1} & {a}_{2 \_ 2} & Λ & {a}_{2 \_ ( n - k )} & {a}_{2 \_ ( n - k + 1 )} & {a}_{2 \_ ( n - k + 2 )} & Λ & {a}_{2 \_n} \\ M & M & Λ & M & M & M & Λ & M \\ {a}_{k\_ 1} & {a}_{k\_ 2} & Λ & {a}_{k\_ ( n - k )} & {a}_{k\_ ( n - k + 1 )} & {a}_{k\_ ( n - k + 2 )} & Λ & {a}_{k\_n}\end{matrix} ] .$$

The redundancy check matrix above has k rows and n columns of elements. Any sub-matrix including k columns of elements among the n columns of elements in the redundancy check matrix should be invertible.

According to the general form of the redundancy check matrix, Equation 6 can be re-written as:

$$[ \begin{matrix}{a}_{1 \_ 1} & {a}_{1 \_ 2} & Λ & {a}_{1 \_ ( n - k )} & {a}_{1 \_ ( n - k + 1 )} & {a}_{1 \_ ( n - k + 2 )} & Λ & {a}_{1 \_n} \\ {a}_{2 \_ 1} & {a}_{2 \_ 2} & Λ & {a}_{2 \_ ( n - k )} & {a}_{2 \_ ( n - k + 1 )} & {a}_{2 \_ ( n - k + 2 )} & Λ & {a}_{2 \_n} \\ M & M & Λ & M & M & M & Λ & M \\ {a}_{k\_ 1} & {a}_{k\_ 2} & Λ & {a}_{k\_ ( n - k )} & {a}_{k\_ ( n - k + 1 )} & {a}_{k\_ ( n - k + 2 )} & Λ & {a}_{k\_n}\end{matrix} ] ⊗ [ \begin{matrix}{D}_{1} \\ {D}_{2} \\ M \\ {D}_{( n - k )} \\ {C}_{1} \\ {C}_{2} \\ M \\ {C}_{k}\end{matrix} ] = [ \begin{matrix}0 \\ 0 \\ M \\ 0\end{matrix} ] . \qquad ( Equation 10 )$$

And according to the general form of the redundancy check matrix, Equation 5 for generating redundancy blocks can also be re-written as:

$$[ \begin{matrix}{C}_{1} \\ {C}_{2} \\ M \\ {C}_{k}\end{matrix} ] = - {[ \begin{matrix}{a}_{1 \_ ( n - k + 1 )} & {a}_{1 \_ ( n - k + 2 )} & Λ & {a}_{1 \_n} \\ {a}_{2 \_ ( n - k + 1 )} & {a}_{2 \_ ( n - k + 2 )} & Λ & {a}_{2 \_n} \\ M & M & Λ & M \\ {a}_{k\_ ( n - k + 1 )} & {a}_{k\_ ( n - k + 2 )} & Λ & {a}_{k\_n}\end{matrix} ]}^{- 1} ⊗ [ \begin{matrix}{a}_{1 \_ 1} & {a}_{1 \_ 2} & Λ & {a}_{1 \_ ( n - k )} \\ {a}_{2 \_ 1} & {a}_{2 \_ 2} & Λ & {a}_{2 \_ ( n - k )} \\ M & M & Λ & M \\ {a}_{k\_ 1} & {a}_{k\_ 2} & Λ & {a}_{k\_ ( n - k )}\end{matrix} ] ⊗ [ \begin{matrix}{D}_{1} \\ {D}_{2} \\ M \\ {D}_{( n - k )}\end{matrix} ] .$$

According to the general form of the redundancy check matrix, Equation 9 for recovering failed code words can be re-written as:

$$[ \begin{matrix}{D}_{f 1} \\ {D}_{f 2} \\ M \\ {D}_{fe}\end{matrix} ] = - {[ \begin{matrix}{a}_{1 \_f1} & {a}_{1 \_f2} & Λ & {a}_{1 \_fe} \\ {a}_{2 \_f1} & {a}_{2 \_f2} & Λ & {a}_{2 \_fe} \\ M & M & Λ & M \\ {a}_{k\_f1} & {a}_{k\_f2} & Λ & {a}_{k\_fe}\end{matrix} ]}^{- 1} ⊗ [ \begin{matrix}{a}_{1 \_ [ g\_ 1 ]} & {a}_{1 \_ [ g\_ 2 ]} & Λ & {a}_{1 \_ [ g\_ ( n - e ) ]} \\ {a}_{2 \_ [ g\_ 1 ]} & {a}_{2 \_ [ g\_ 2 ]} & Λ & {a}_{2 \_ [ g\_ ( n - e ) ]} \\ M & M & Λ & M \\ {a}_{k\_ [ g\_ 1 ]} & {a}_{k\_ [ g\_ 2 ]} & Λ & {a}_{k\_ [ g\_ ( n - e ) ]}\end{matrix} ] ⊗ [ \begin{matrix}{D}_{g\_ 1} \\ {D}_{g\_ 2} \\ M \\ {D}_{g\_ ( n - e )}\end{matrix} ] .$$

In the second preferred embodiment according to this invention, the redundancy check matrix can be generated based on a k-th order Reed-Solomon code generator polynomial.

Reed-Solomon codes are designed using the principles of finite field theory. A field is a set of elements along with two defined operations on the elements. The two operations are typically denoted by operators ‘+’ and ‘×’. A field is constructed so as to have the following properties: (a) the field is closed under both operators; (b) both operators are commutative; (c) both operators are associative; (d) each operator has a unique identity element (if a is a element of the field, so are a+0=a and a×1=a); (e) one operator is distributive across the other; (f) every element has a unique additive inverse (a+[−a]=0); and (g) every non-zero element has a unique multiplicative inverse (a×a⁻¹=1). Fields that are finite (the number of elements are not infinite) are called “Galois field” and denoted GF(p), wherein p is the number of elements in the field.

The k roots of the k-th order Reed-Solomon code generator polynomial are {1, a, a², . . . , a^{k-1}}, wherein the coefficient field is GF(q^{P}), a is a primitive element of the coefficient field GF(q^{P}), q is a prime number, and P is a positive integer. The redundancy check matrix (R2) generated according to the generator polynomial is represented as:

$$R 2 = [ \begin{matrix}1 & Λ & 1 & 1 & 1 & Λ & 1 & 1 \\ {a}^{n - 1} & Λ & {a}^{( k + 1 )} & {a}^{k} & {a}^{k - 1} & Λ & a & 1 \\ M & M & M & M & M & M & M & M \\ {a}^{( n - 1 ) ( k - 1 )} & Λ & {a}^{( k + 1 ) ( k - 1 )} & {a}^{k ( k - 1 )} & {a}^{( k - 1 ) ( k - 1 )} & Λ & {a}^{( k - 1 )} & 1\end{matrix} ] .$$

Because the primitive elements in the GF(q^{P}) are closed under the ‘+’ and ‘×’ operators, the size of each redundancy block generated based on the redundancy check matrix R2 is the same as the size of each data block. On the contrast, if the elements in a redundancy check matrix are not closed under the ‘+’ and ‘×’ operators, the size of each redundancy block might be twice larger than the size of each data block. Accordingly, as long as the redundancy matrix according to this invention is generated based on elements in a Galois field, the spaces for storing redundancy blocks can be retrenched.

Furthermore, more and more processors are implemented with Galois Field multipliers (or accelerators) in recent years. Using the processors with Galois Field multipliers, the second preferred embodiment can be implemented efficiently.

In the second preferred embodiment according to this invention, the operations with redundancy check matrix generated according to Reed-Solomon generator polynomial are the same as the operations with Vandermonde matrixes in the first preferred embodiment according to this invention; thus, the former is not further described here.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. In a data storage system, a redundancy check matrix with k rows and n columns of elements being previously provided, any sub-matrix comprising k columns of elements among the n columns of elements in the redundancy check matrix being invertible, k being a natural number and n being a natural number larger than k, said data storage system comprising:
an array of storage devices configured to store information in the form of a plurality of stripes; and
a storage controller coupled to the array of storage devices and configured to write a plurality of code words forming each stripe to the array of storage devices;
wherein said plurality of code words represents a systematic mapping of a plurality of data blocks according to the redundancy check matrix and comprises said plurality of data blocks and at least one redundancy block, and
wherein said storage controller comprises an encoder configured to generate said at least one redundancy block according to the plurality of data blocks and the redundancy check matrix in an encoding mode.

2. The data storage system of claim 1, wherein once up to k storage devices in the array of storage devices are failed, the data storage system recovers the code words in the failed storage devices based on the redundancy check matrix and the code words in the other un-failed storage devices.

3. The data storage system of claim 1, wherein the array of storage devices comprises a plurality of disk drives.

4. The data storage system of claim 1, wherein the array of storage devices comprises n storage devices, a first stripe in the array of storage devices comprises (n-k) subsets of data blocks (D₁, D₂, . . . , D₍ₙ₋ₖ₎) and k subsets of redundancy blocks (C₁, C₂, . . . , Cₖ) generated by the encoder, each subset is stored in one storage device in the array of storage device, respectively, the redundancy check matrix is:
$$[ \begin{matrix}{a}_{1 \_ 1} & {a}_{1 \_ 2} & Λ & {a}_{1 \_ ( n - k )} & {a}_{1 \_ ( n - k + 1 )} & {a}_{1 \_ ( n - k + 2 )} & Λ & {a}_{1 \_n} \\ {a}_{2 \_ 1} & {a}_{2 \_ 2} & Λ & {a}_{2 \_ ( n - k )} & {a}_{2 \_ ( n - k + 1 )} & {a}_{2 \_ ( n - k + 2 )} & Λ & {a}_{2 \_n} \\ M & M & Λ & M & M & M & Λ & M \\ {a}_{k\_ 1} & {a}_{k\_ 2} & Λ & {a}_{k\_ ( n - k )} & {a}_{k\_ ( n - k + 1 )} & {a}_{k\_ ( n - k + 2 )} & Λ & {a}_{k\_n}\end{matrix} ] ,$$
and the relation between the (n-k) subsets of data blocks and k subsets of redundancy blocks is:
$$[ \begin{matrix}{a}_{1 \_ 1} & {a}_{1 \_ 2} & Λ & {a}_{1 \_ ( n - k )} & {a}_{1 \_ ( n - k + 1 )} & {a}_{1 \_ ( n - k + 2 )} & Λ & {a}_{1 \_n} \\ {a}_{2 \_ 1} & {a}_{2 \_ 2} & Λ & {a}_{2 \_ ( n - k )} & {a}_{2 \_ ( n - k + 1 )} & {a}_{2 \_ ( n - k + 2 )} & Λ & {a}_{2 \_n} \\ M & M & Λ & M & M & M & Λ & M \\ {a}_{k\_ 1} & {a}_{k\_ 2} & Λ & {a}_{k\_ ( n - k )} & {a}_{k\_ ( n - k + 1 )} & {a}_{k\_ ( n - k + 2 )} & Λ & {a}_{k\_n}\end{matrix} ] ⊗ [ \begin{matrix}{D}_{1} \\ {D}_{2} \\ M \\ {D}_{( n - k )} \\ {C}_{1} \\ {C}_{2} \\ M \\ {C}_{k}\end{matrix} ] = [ \begin{matrix}0 \\ 0 \\ M \\ 0\end{matrix} ] .$$

5. The data storage system of claim 4, wherein the encoder generates the k subsets of redundancy blocks according to a generator matrix which is generated based on the redundancy check matrix and represented as:
$${[ \begin{matrix}{a}_{1 \_ ( n - k + 1 )} & {a}_{1 \_ ( n - k + 2 )} & Λ & {a}_{1 \_n} \\ {a}_{2 \_ ( n - k + 1 )} & {a}_{2 \_ ( n - k + 2 )} & Λ & {a}_{2 \_n} \\ M & M & Λ & M \\ {a}_{k\_ ( n - k + 1 )} & {a}_{k\_ ( n - k + 2 )} & Λ & {a}_{k\_n}\end{matrix} ]}^{- 1} ⊗ [ \begin{matrix}{a}_{1 \_ 1} & {a}_{1 \_ 2} & Λ & {a}_{1 \_ ( n - k )} \\ {a}_{2 \_ 1} & {a}_{2 \_ 2} & Λ & {a}_{2 \_ ( n - k )} \\ M & M & Λ & M \\ {a}_{k\_ 1} & {a}_{k\_ 2} & Λ & {a}_{k\_ ( n - k )}\end{matrix} ] ,$$
and the relation between the generator matrix, the (n-k) subsets of data blocks, and the k subsets of redundancy blocks is:
$$[ \begin{matrix}{C}_{1} \\ {C}_{2} \\ M \\ {C}_{k}\end{matrix} ] = - {[ \begin{matrix}{a}_{1 \_ ( n - k + 1 )} & {a}_{1 \_ ( n - k + 2 )} & Λ & {a}_{1 \_n} \\ {a}_{2 \_ ( n - k + 1 )} & {a}_{2 \_ ( n - k + 2 )} & Λ & {a}_{2 \_n} \\ M & M & Λ & M \\ {a}_{k\_ ( n - k + 1 )} & {a}_{k\_ ( n - k + 2 )} & Λ & {a}_{k\_n}\end{matrix} ]}^{- 1} ⊗ \\ [ \begin{matrix}{a}_{1 \_ 1} & {a}_{1 \_ 2} & Λ & {a}_{1 \_ ( n - k )} \\ {a}_{2 \_ 1} & {a}_{2 \_ 2} & Λ & {a}_{2 \_ ( n - k )} \\ M & M & Λ & M \\ {a}_{k\_ 1} & {a}_{k\_ 2} & Λ & {a}_{k\_ ( n - k )}\end{matrix} ] ⊗ [ \begin{matrix}{D}_{1} \\ {D}_{2} \\ M \\ {D}_{( n - k )}\end{matrix} ] .$$

6. The data storage system of claim 4, wherein a second stripe in the array of storage devices comprises n code words, each code word is stored in one storage device in the array of storage device, respectively, the storage controller further comprises a recovering module, once e code words (D_{f1}, D_{f2}, . . . , D_{fe}) among the n code words are failed, the recovering module recovers the e failed code words based on a recovery matrix and the other (n-e) un-failed code words (D_{g}_{_{—}}₁, D_{g}_{_{—}}₂, . . . , D_{g}_{_{—}}₍ₙ₋ₑ₎), the recovery matrix is generated based on the redundancy check matrix and represented as:
$${[ \begin{matrix}{a}_{1 \_f1} & {a}_{1 \_f2} & Λ & {a}_{1 \_fe} \\ {a}_{2 \_f1} & {a}_{2 \_f2} & Λ & {a}_{2 \_fe} \\ M & M & Λ & M \\ {a}_{k\_f1} & {a}_{k\_f2} & Λ & {a}_{k\_fe}\end{matrix} ]}^{- 1} ⊗ [ \begin{matrix}{a}_{1 \_ [ g\_ 1 ]} & {a}_{1 \_ [ g\_ 2 ]} & Λ & {a}_{1 \_ [ g\_ ( n - e ) ]} \\ {a}_{2 \_ [ g\_ 1 ]} & {a}_{2 \_ [ g\_ 2 ]} & Λ & {a}_{2 \_ [ g\_ ( n - e ) ]} \\ M & M & Λ & M \\ {a}_{k\_ [ g\_ 1 ]} & {a}_{k\_ [ g\_ 2 ]} & Λ & {a}_{k\_ [ g\_ ( n - e ) ]}\end{matrix} ] ,$$
wherein e is a natural number smaller than or equal to k, {f1, f2, . . . , fe} is a subset of {1, 2, . . . , n}, {g_{—}1, g_{—}2, . . . , g_(n-e)} is an another subset of {1, 2, . . . , n}, and any element in {g_{—}1, g_{—}2, . . . , g_(n-e)} doesn't belong to the subset {f1, f2, . . . , fe}, and the relation between the recovery matrix, the (n-e) un-failed code words, and the e failed code words is:
$$[ \begin{matrix}{D}_{f 1} \\ {D}_{f 2} \\ M \\ {D}_{fe}\end{matrix} ] = - {[ \begin{matrix}{a}_{1 \_f1} & {a}_{1 \_f2} & Λ & {a}_{1 \_fe} \\ {a}_{2 \_f1} & {a}_{2 \_f2} & Λ & {a}_{2 \_fe} \\ M & M & Λ & M \\ {a}_{k\_f1} & {a}_{k\_f2} & Λ & {a}_{k\_fe}\end{matrix} ]}^{- 1} ⊗ \\ [ \begin{matrix}{a}_{1 \_ [ g\_ 1 ]} & {a}_{1 \_ [ g\_ 2 ]} & Λ & {a}_{1 \_ [ g\_ ( n - e ) ]} \\ {a}_{2 \_ [ g\_ 1 ]} & {a}_{2 \_ [ g\_ 2 ]} & Λ & {a}_{2 \_ [ g\_ ( n - e ) ]} \\ M & M & Λ & M \\ {a}_{k\_ [ g\_ 1 ]} & {a}_{k\_ [ g\_ 2 ]} & Λ & {a}_{k\_ [ g\_ ( n - e ) ]}\end{matrix} ] ⊗ [ \begin{matrix}{D}_{g\_ 1} \\ {D}_{g\_ 2} \\ M \\ {D}_{g\_ ( n - e )}\end{matrix} ]$$

7. The data storage system of claim 1, wherein the redundancy check matrix R is a Vandermonde matrix and represented as:
$$R = [ \begin{matrix}1 & 1 & Λ & 1 & 1 & 1 & Λ & 1 \\ {a}_{1} & {a}_{2} & Λ & {a}_{( n - k )} & {a}_{n - k + 1} & {a}_{( n - k + 2 )} & Λ & {a}_{n} \\ M & M & Λ & M & M & M & Λ & M \\ {a}_{1}^{k - 1} & {a}_{2}^{k - 1} & Λ & {a}_{( n - k )}^{k - 1} & {a}_{( n - k + 1 )}^{k - 1} & {a}_{( n - k + 2 )}^{k - 1} & Λ & {a}_{n}^{k - 1}\end{matrix} ] ,$$
wherein {a₁, a₂, . . . , aₙ} are n elements different from each other.

8. The data storage system of claim 7, wherein the array of storage devices comprises n storage devices, a first stripe in the array of storage devices comprises (n-k) subsets of data blocks (D₁, D₂, . . . , D₍ₙ₋ₖ₎) and k subsets of redundancy blocks (C₁, C₂, . . . , Cₖ) generated by the encoder, each subset is stored in one storage device in the array of storage device, respectively, the relation between the (n-k) subsets of data blocks and k subsets of redundancy blocks is:
$$[ \begin{matrix}1 & 1 & Λ & 1 & 1 & 1 & Λ & 1 \\ {a}_{1} & {a}_{2} & Λ & {a}_{( n - k )} & {a}_{n - k + 1} & {a}_{( n - k + 2 )} & Λ & {a}_{n} \\ M & M & Λ & M & M & M & Λ & M \\ {a}_{1}^{k - 1} & {a}_{2}^{k - 1} & Λ & {a}_{( n - k )}^{k - 1} & {a}_{( n - k + 1 )}^{k - 1} & {a}_{( n - k + 2 )}^{k - 1} & Λ & {a}_{n}^{k - 1}\end{matrix} ] ⊗ [ \begin{matrix}{D}_{1} \\ {D}_{2} \\ M \\ {D}_{( n - k )} \\ {C}_{1} \\ {C}_{2} \\ M \\ {C}_{k}\end{matrix} ] = [ \begin{matrix}0 \\ 0 \\ M \\ 0\end{matrix} ] .$$

9. The data storage system of claim 8, wherein the encoder generates the k subsets of redundancy blocks according to a generator matrix which is generated based on the Vandermonde matrix and represented as:
$${[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ [ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{n}^{k - 1}\end{matrix} ] ,$$
and the relation between the generator matrix, the (n-k) subsets of data blocks, and the k subsets of redundancy blocks is:
$$[ \begin{matrix}{C}_{1} \\ {C}_{2} \\ M \\ {C}_{k}\end{matrix} ] = - {[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ \\ [ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{n}^{k - 1}\end{matrix} ] ⊗ [ \begin{matrix}{D}_{1} \\ {D}_{2} \\ M \\ {D}_{( n - k )}\end{matrix} ]$$

10. The data storage system of claim 7, wherein the array of storage devices comprises n storage devices, a second stripe in the array of storage devices comprises n code words, each code word is stored in one storage device in the array of storage device, respectively, the storage controller further comprises a recovering module, once e code words (D_{f1}, D_{f2}, . . . , D_{fe}) among the n code words are failed, the recovering module recovers the e failed code words based on a recovery matrix and the (n-e) un-failed code words (D_{g}_{_{—}}₁, D_{g}_{_{—}}₂, . . . , D_{g}_{_{—}}₍ₙ₋ₑ₎), the recovery matrix is generated based on the Vandermonde matrix and represented as:
$${[ \begin{matrix}{a}_{f 1}^{i\_ 1} & {a}_{f 2}^{i\_ 1} & Λ & {a}_{fe}^{i\_ 1} \\ {a}_{f 1}^{i\_ 2} & {a}_{f 2}^{i\_ 2} & Λ & {a}_{fe}^{i\_ 2} \\ M & M & Λ & M \\ {a}_{f 1}^{i\_e} & {a}_{f 2}^{i\_e} & Λ & {a}_{fe}^{i\_e}\end{matrix} ]}^{- 1} ⊗ [ \begin{matrix}{a}_{g\_ 1}^{i\_ 1} & {a}_{g\_ 2}^{i\_ 1} & Λ & {a}_{g\_ ( n - e )}^{i\_ 1} \\ {a}_{g\_ 1}^{i\_ 2} & {a}_{g\_ 2}^{i\_ 2} & Λ & {a}_{g\_ ( n - e )}^{i\_ 2} \\ M & M & Λ & M \\ {a}_{g\_ 1}^{i\_e} & {a}_{g\_ 2}^{i\_e} & Λ & {a}_{g\_ ( n - e )}^{i\_e}\end{matrix} ] ,$$
e is a natural number smaller than or equal to k, {f1, f2, . . . , fe} is a subset of {1, 2, . . . , n}, {g_{—}1, g_{—}2, . . . , g_(n-e)} is an another subset of {1, 2, . . . , n}, any element in {g_{—}1, g_{—}2, . . . , g_(n-e)} doesn't belong to the subset {f1, f2, . . . , fe}, {i_{—}1, i_{—}2, . . . , i_e} is formed by selecting e different elements from the k elements in {0, 1, . . . , (k−1)}, and the relation between the recovery matrix, the (n-e) un-failed code words, and the e failed code words is:
$$[ \begin{matrix}\begin{matrix}\begin{matrix}{D}_{f 1} \\ {D}_{f 2}\end{matrix} \\ M\end{matrix} \\ {D}_{fe}\end{matrix} ] = - {[ \begin{matrix}{a}_{f 1}^{i\_ 1} & {a}_{f 2}^{i\_ 1} & Λ & {a}_{fe}^{i\_ 1} \\ {a}_{f 1}^{i\_ 2} & {a}_{f 2}^{i\_ 2} & Λ & {a}_{fe}^{i\_ 2} \\ M & M & Λ & M \\ {a}_{f 1}^{i\_e} & {a}_{f 2}^{i\_e} & Λ & {a}_{fe}^{i\_e}\end{matrix} ]}^{- 1} ⊗ \\ [ \begin{matrix}{a}_{g\_ 1}^{i\_ 1} & {a}_{g\_ 2}^{i\_ 1} & Λ & {a}_{g\_ ( n - e )}^{i\_ 1} \\ {a}_{g\_ 1}^{i\_ 2} & {a}_{g\_ 2}^{i\_ 2} & Λ & {a}_{g\_ ( n - e )}^{i\_ 2} \\ M & M & Λ & M \\ {a}_{g\_ 1}^{i\_e} & {a}_{g\_ 2}^{i\_e} & Λ & {a}_{g\_ ( n - e )}^{i\_e}\end{matrix} ] ⊗ [ \begin{matrix}\begin{matrix}\begin{matrix}{D}_{g\_ 1} \\ {D}_{g\_ 2}\end{matrix} \\ M\end{matrix} \\ {D}_{g\_ ( n - e )}\end{matrix} ] .$$

11. The data storage system of claim 1, wherein the redundancy check matrix R is a Vandermonde matrix and represented as:
$$R = [ \begin{matrix}{b}_{0} & {b}_{0} & Λ & {b}_{0} & {b}_{0} & {b}_{0} & Λ & {b}_{0} \\ {b}_{1} {a}_{1} & {b}_{1} {a}_{2} & Λ & {b}_{1} {a}_{( n - k )} & {b}_{1} {a}_{( n - k + 1 )} & {b}_{1} {a}_{( n - k + 2 )} & Λ & {b}_{1} {a}_{n} \\ M & M & Λ & M & M & M & Λ & M \\ {b}_{( k - 1 )} {a}_{1}^{k - 1} & {b}_{( k - 1 )} {a}_{2}^{k - 1} & Λ & {b}_{( k - 1 )} {a}_{( n - k )}^{k - 1} & {b}_{( k - 1 )} {a}_{( n - k + 1 )}^{k - 1} & {b}_{( k - 1 )} {a}_{( n - k + 2 )}^{k - 1} & Λ & {b}_{( k - 1 )} {a}_{n}^{k - 1}\end{matrix} ] ,$$
wherein {a₁, a₂, . . . , aₙ} are n elements different from each other and {b₀, b₁, . . . , b₍ₖ₋₁₎} are non-zero constants.

12. The data storage system of claim 1, wherein the redundancy check matrix R is a Vandermonde matrix and represented as:
$$R = [ \begin{matrix}{b}_{1} & {b}_{2} & Λ & {b}_{( n - k )} & {b}_{( n - k + 1 )} & {b}_{( n - k + 2 )} & Λ & {b}_{n} \\ {b}_{1} {a}_{1} & {b}_{2} {a}_{a} & Λ` & {b}_{( n - k )} {a}_{( n - k )} & {b}_{( n - k + 1 )} {a}_{( n - k + 1 )} & {b}_{( n - k + 2 )} {a}_{( n - k + 2 )} & Λ & {b}_{n} {a}_{n} \\ M & M & Λ & M & M & M & Λ & M \\ {b}_{1} {a}_{1}^{k - 1} & {b}_{2} {a}_{2}^{k - 1} & Λ & {b}_{( n - k )} {a}_{( n - k )}^{k - 1} & {b}_{( n - k + 1 )} {a}_{( n - k + 1 )}^{k - 1} & {b}_{( n - k + 2 )} {a}_{( n - k + 2 )}^{k - 1} & Λ & {b}_{n} {a}_{n}^{k - 1}\end{matrix} ] ,$$
wherein {a₁, a₂, . . . , aₙ} are n elements different from each other and {b₁, b₂, bₙ} are non-zero constants.

13. The data storage system of claim 1, wherein the redundancy check matrix R is generated according to a k-th order Reed-Solomon code generator polynomial, and the k roots of the generator polynomial are {1, a, a², . . . , a^{k-1}}, wherein the coefficient field is GF(q^{P}), a is a primitive element of the coefficient field GF(q^{P}), q is a prime number, P is a positive integer, and the redundancy check matrix R is represented as:
$$R = [ \begin{matrix}1 & Λ & 1 & 1 & 1 & Λ & 1 & 1 \\ {a}^{n - 1} & Λ & {a}^{( k + 1 )} & {a}^{k} & {a}^{k - 1} & Λ & a & 1 \\ M & M & M & M & M & M & M & M \\ {a}^{( n - 1 ) ( k - 1 )} & Λ & {a}^{( k + 1 ) ( k - 1 )} & {a}^{k ( k - 1 )} & {a}^{( k - 1 ) ( k - 1 )} & Λ & {a}^{( k - 1 )} & 1\end{matrix} ] .$$

14. The data storage system of claim 13, wherein the array of storage devices comprises n storage devices, a first stripe in the array of storage devices comprises (n-k) subsets of data blocks (D₁, D₂, . . . , D₍ₙ₋ₖ₎) and k subsets of redundancy blocks (C₁, C₂, . . . , Cₖ) generated by the encoder, each subset is stored in one storage device in the array of storage device, respectively, and the relation between the (n-k) subsets of data blocks and k subsets of redundancy blocks is:
$$[ \begin{matrix}1 & Λ & 1 & 1 & 1 & Λ & 1 & 1 \\ {a}^{n - 1} & Λ & {a}^{( k + 1 )} & {a}^{k} & {a}^{k - 1} & Λ & a & 1 \\ M & M & M & M & M & M & M & M \\ {a}^{( n - 1 ) ( k - 1 )} & Λ` & {a}^{( k + 1 ) ( k - 1 )} & {a}^{k ( k - 1 )} & {a}^{( k - 1 ) ( k - 1 )} & Λ & {a}^{( k - 1 )} & 1\end{matrix} ] ⊗ \\ [ \begin{matrix}{D}_{1} \\ M \\ {D}_{( n - k - 1 )} \\ {D}_{( n - k )} \\ {C}_{1} \\ M \\ {C}_{( k - 1 )} \\ {C}_{k}\end{matrix} ] = [ \begin{matrix}0 \\ 0 \\ M \\ 0\end{matrix} ] .$$

15. The data storage system of claim 14, wherein the encoder generates the k subsets of redundancy blocks according to a generator matrix which is generated based on the redundancy check matrix and represented as:
$${[ \begin{matrix}1 & Λ & 1 & 1 \\ {a}^{k - 1} & Λ & a & 1 \\ M & M & Λ & M \\ {a}^{( k - 1 ) ( k - 1 )} & Λ & {a}^{( k - 1 )} & 1\end{matrix} ]}^{- 1} ⊗ [ \begin{matrix}1 & Λ & 1 & 1 \\ {a}^{n - 1} & Λ & {a}^{k + 1} & {a}^{k} \\ M & M & Λ & M \\ {a}^{( n - 1 ) ( k - 1 )} & Λ & {a}^{( k + 1 ) ( k - 1 )} & {a}^{k ( k - 1 )}\end{matrix} ] ,$$
and the relation between the generator matrix, the (n-k) subsets of data blocks, and the k subsets of redundancy blocks is:
$$[ \begin{matrix}{C}_{1} \\ {C}_{2} \\ M \\ {C}_{k}\end{matrix} ] = {[ \begin{matrix}1 & Λ & 1 & 1 \\ {a}^{k - 1} & Λ & a & 1 \\ M & M & Λ & M \\ {a}^{( k - 1 ) ( k - 1 )} & Λ & {a}^{( k - 1 )} & 1\end{matrix} ]}^{- 1} ⊗ \\ [ \begin{matrix}1 & Λ & 1 & 1 \\ {a}^{n - 1} & Λ & {a}^{k + 1} & {a}^{k} \\ M & M & Λ & M \\ {a}^{( n - 1 ) ( k - 1 )} & Λ & {a}^{( k + 1 ) ( k - 1 )} & {a}^{k ( k - 1 )}\end{matrix} ] ⊗ [ \begin{matrix}{D}_{1} \\ {D}_{2} \\ M \\ {D}_{( n - k )}\end{matrix} ] .$$

16. The data storage system of claim 13, wherein the array of storage devices comprises n storage devices, a second stripe in the array of storage devices comprises n code words, each code word is stored in one storage device in the array of storage device, respectively, the storage controller further comprises a recovering module, once e code words (D_{f1}, D_{f2}, . . . , D_{fe}) among the n code words are failed, the recovering module recovers the e failed code words based on a recovery matrix and the (n-e) un-failed code words (D_{g}_{_{—}}₁, D_{g}_{_{—}}₂, . . . , D_{g}_{_{—}}₍ₙ₋ₑ₎), the recovery matrix is generated based on the redundancy check matrix and represented as:
$${[ \begin{matrix}{a}_{f 1}^{i\_ 1} & {a}_{f 2}^{i\_ 1} & Λ & {a}_{fe}^{i\_ 1} \\ {a}_{f 1}^{i\_ 2} & {a}_{f 2}^{i\_ 2} & Λ & {a}_{fe}^{i\_ 2} \\ M & M & Λ & M \\ {a}_{f 1}^{i\_e} & {a}_{f 2}^{i\_e} & Λ & {a}_{fe}^{i\_e}\end{matrix} ]}^{- 1} ⊗ [ \begin{matrix}{a}_{g\_ 1}^{i\_ 1} & {a}_{g\_ 2}^{i\_ 1} & Λ & {a}_{g\_ ( n - e )}^{i\_ 1} \\ {a}_{g\_ 1}^{i\_ 2} & {a}_{g\_ 2}^{i\_ 2} & Λ & {a}_{g\_ ( n - e )}^{i\_ 2} \\ M & M & Λ & M \\ {a}_{g\_ 1}^{i\_e} & {a}_{g\_ 2}^{i\_e} & Λ & {a}_{g\_ ( n - e )}^{i\_e}\end{matrix} ] ,$$
e is a natural number smaller than or equal to k, {a_{f1}, a_{f2}, . . . , a_{fe}} is a subset of {1, a, a², . . . , a^{k-1}}, {a_{g}_{_{—}}₁, a_{g}_{_{—}}₂, . . . , a_{g}_{_{—}}₍ₙ₋ₑ₎} is an another subset of {1, a, a², . . . , a^{k-1}}, any element in {a_{g}_{_{—}}₁, a_{g}_{_{—}}₂, . . . , a_{g}_{_{—}}₍ₙ₋ₑ₎} doesn't belong to the subset {a_{f1}, a_{f2}, . . . , a_{fe}}, {i_{—}1, i_{—}2, . . . , i_e} is formed by selecting e different elements from the k elements in {0, 1, . . . , (k−1)}, and the relation between the recovery matrix, the (n-e) un-failed code words, and the e failed code words is:
$$[ \begin{matrix}{D}_{f 1} \\ {D}_{f 2} \\ M \\ {D}_{fe}\end{matrix} ] = - {[ \begin{matrix}{a}_{f 1}^{i\_ 1} & {a}_{f 2}^{i\_ 1} & Λ & {a}_{fe}^{i\_ 1} \\ {a}_{f 1}^{i\_ 2} & {a}_{f 2}^{i\_ 2} & Λ & {a}_{fe}^{i\_ 2} \\ M & M & Λ & M \\ {a}_{f 1}^{i\_e} & {a}_{f 2}^{i\_e} & Λ & {a}_{fe}^{i\_e}\end{matrix} ]}^{- 1} ⊗ \\ [ \begin{matrix}{a}_{g\_ 1}^{i\_ 1} & {a}_{g\_ 2}^{i\_ 1} & Λ & {a}_{g\_ ( n - e )}^{i\_ 1} \\ {a}_{g\_ 1}^{i\_ 2} & {a}_{g\_ 2}^{i\_ 2} & Λ & {a}_{g\_ ( n - e )}^{i\_ 2} \\ M & M & Λ & M \\ {a}_{g\_ 1}^{i\_e} & {a}_{g\_ 2}^{i\_e} & Λ & {a}_{g\_ ( n - e )}^{i\_e}\end{matrix} ] ⊗ [ \begin{matrix}\begin{matrix}\begin{matrix}{D}_{g\_ 1} \\ {D}_{g\_ 2}\end{matrix} \\ M\end{matrix} \\ {D}_{g\_ ( n - e )}\end{matrix} ] .$$

17. A method of generating k redundancy blocks (C₁, C₂, . . . , Cₖ) for (n-k) data blocks (D₁, D₂, . . . , D₍ₙ₋ₖ₎), k being a natural number, n being a natural number larger than k, a previously provided Vandermonde matrix (R) with k rows and n columns of elements being represented as:
$$R = [ \begin{matrix}1 & 1 & Λ & 1 & 1 & 1 & Λ & 1 \\ {a}_{1} & {a}_{2} & Λ & {a}_{( n - k )} & {a}_{( n - k + 1 )} & {a}_{( n - k + 2 )} & Λ & {a}_{n} \\ M & M & Λ & M & M & M & Λ & M \\ {a}_{1}^{k - 1} & {a}_{2}^{k - 1} & Λ & {a}_{( n - k )}^{k - 1} & {a}_{( n - k + 1 )}^{k - 1} & {a}_{( n - k + 2 )}^{k - 1} & Λ & {a}_{n}^{k - 1}\end{matrix} ] ,$$
and the k redundancy blocks being generated according to the following equation:
$$[ \begin{matrix}\begin{matrix}\begin{matrix}{C}_{1} \\ {C}_{2}\end{matrix} \\ M\end{matrix} \\ {C}_{k}\end{matrix} ] = - {[ \begin{matrix}1 & 1 & Λ & 1 \\ {a}_{( n - k + 1 )} & {a}_{( n - k + 2 )} & Λ & {a}_{n} \\ M & M & Λ & M \\ {a}_{( n - k + 1 )}^{k - 1} & {a}_{( n - k + 2 )}^{k - 1} & Λ & {a}_{n}^{k - 1}\end{matrix} ]}^{- 1} ⊗ \\ [ \begin{matrix}1 & 1 & Λ & 1 \\ {a}_{1} & {a}_{2} & Λ & {a}_{( n - k )} \\ M & M & Λ & M \\ {a}_{1}^{k - 1} & {a}_{2}^{k - 1} & Λ & {a}_{n}^{k - 1}\end{matrix} ] ⊗ [ \begin{matrix}\begin{matrix}\begin{matrix}{D}_{1} \\ {D}_{2}\end{matrix} \\ M\end{matrix} \\ {D}_{( n - k )}\end{matrix} ] .$$

18. The method of claim 17, wherein once up to k blocks among the (n-k) data blocks and the k redundancy blocks are failed, the method recovers the failed blocks based on the Vandermonde matrix and the other un-failed blocks.

19. A method of generating k redundancy blocks (C₁, C₂, . . . , Cₖ) for (n-k) data blocks (D₁, D₂, . . . , D₍ₙ₋ₖ₎), k being a natural number, n being a natural number larger than k, a redundancy check matrix (R) generated according to a k-th order Reed-Solomon code generator polynomial being previously provided, the k roots of the generator polynomial being {1, a, a², . . . , a^{k-1}}, wherein the coefficient field is GF(q^{P}), a is a primitive element of the coefficient field GF(q^{P}), q is a prime number, P is a positive integer, the redundancy check matrix (R) with k rows and n columns of elements being represented as:
$$R = [ \begin{matrix}1 & Λ & 1 & 1 & 1 & Λ & 1 & 1 \\ {a}^{n - 1} & Λ & {a}^{( k + 1 )} & {a}^{k} & {a}^{k - 1} & Λ & a & 1 \\ M & M & M & M & M & M & M & M \\ {a}^{( n - 1 ) ( k - 1 )} & Λ & {a}^{( k + 1 ) ( k - 1 )} & {a}^{k ( k - 1 )} & {a}^{( k - 1 ) ( k - 1 )} & Λ & {a}^{( k - 1 )} & 1\end{matrix} ] ,$$
and the k redundancy blocks are generated according to the following equation:
$$[ \begin{matrix}{C}_{1} \\ {C}_{2} \\ M \\ {C}_{k}\end{matrix} ] = {[ \begin{matrix}1 & Λ & 1 & 1 \\ {a}^{( k - 1 )} & Λ & a & 1 \\ M & M & Λ & M \\ {a}^{( k - 1 ) ( k - 1 )} & Λ & {a}^{( k - 1 )} & 1\end{matrix} ]}^{- 1} ⊗ \\ [ \begin{matrix}1 & Λ & 1 & 1 \\ {a}^{n - 1} & Λ & {a}^{k + 1} & {a}^{k} \\ M & M & Λ & M \\ {a}^{( n - 1 ) ( k - 1 )} & Λ & {a}^{( k + 1 ) ( k - 1 )} & {a}^{k ( k - 1 )}\end{matrix} ] ⊗ [ \begin{matrix}{D}_{1} \\ {D}_{2} \\ M \\ {D}_{( n - k )}\end{matrix} ] .$$

20. The method of claim 19, wherein once up to k blocks among the (n-k) data blocks and the k redundancy blocks are failed, the method recovers the failed blocks based on the redundancy check matrix and the other un-failed blocks.
